(19) United States
(12) Patent Application Publication
(10) Pub. No.: US 2009/0129208 A1
(43) Pub. Date: May 21, 2009

(54) APPARATUS, SYSTEM AND METHOD FOR KEEPING TIME

(76) Inventor: Kenneth P. Weiss, Newton, MA (US)

Correspondence Address: LOWRIE, LANDO & ANASTASI, LLP, ONE MAIN STREET, SUITE 1100, CAMBRIDGE, MA, 02142, US

(21) Appl. No.: 12/361,370

(22) Filed: Jan. 28, 2009

(51) Int. Cl. G04C 13/04

(52) U.S. Cl. 368/56; 368/52

(57) ABSTRACT

According to one aspect, the invention provides a method of synchronizing a clock included in a device. According to one embodiment, the method includes acts of: (a) receiving with the device a clock signal including a time standard provided by a reference clock; (b) determining an elapsed time since a prior receipt of a clock signal including a time standard provided by the reference clock; (c) determining an error between a time provided by the clock signal received in act (a) and a time maintained by the clock included in the device; and (d) adjusting the time maintained by the clock included in the device to correct for the error determined by act (c), where the reference clock comprises an atomic clock.

### BACKGROUND OF INVENTION

1. Field of the Invention

Embodiments of the invention relate generally to keeping time more precisely. More specifically, at least one embodiment, relates to a method and a system for adjusting the time calculations in a device to improve the accuracy of the calculated times.

2. Discussion of Related Art

Advances in technology during the 20^{th} century led to the development of the atomic clock and the transmission of a highly-accurate uniform time standard (based on the time provided by the atomic clock) on a national and international level. In the U.S., the National Institute of Standards and Technology (NIST) broadcasts a radio signal synchronized to an atomic clock. The signal is transmitted via NIST radio station WWVB located near Fort Collins, Colo. The time code provided in the NIST signal includes the year, day of year, hour, minute, second, and flags that indicate the status of Daylight Saving Time, leap years, and leap seconds. Various devices including watches, clocks, GPS devices, computers, servers, digital video recorders (“DVRs”), satellite systems, personal digital assistants (“PDAs’) and mobile phones provide some examples of devices that can receive the NIST signal either directly or indirectly. These “distributed devices” remote from the source of the transmission can then update their time to approximately match the time provided by the atomic clock.

Although the transmission is intended to cover most of the continental U.S. on a daily basis, distributed devices often fail to receive the signal daily or even weekly due to local sources of interference, the antenna positioning of the device and other factors which can effect the strength of the signal received by these devices. Accordingly, the distributed devices may provide a time that becomes increasingly less accurate as the period between receipt of the NIST transmissions increases.

Often, distributed devices employ a crystal oscillator as the basis for keeping track of time internally. Generally, the time calculations are derived using clock-generator circuits that may employ logic elements such as counters to divide down the resonant frequency of the crystal (for example, a quartz crystal) to a desired frequency output. Often, the frequency output is generated as a series of pulses in a signal having the desired frequency. One or more counters may count the pulses up to a fixed target count which when reached indicates that a predetermined period of time has elapsed. Although, the crystals employed in these devices can be used to generate a relatively accurate and repeatable frequency output, manufacturing tolerances often result in the frequency output including an error when compared with a frequency standard that the oscillator is intended to replicate. This error can lead to error in the time calculations. The deviation between the desired frequency output and the actual frequency output in crystal oscillators found in these devices at the time of manufacture and/or device initialization is referred to as an “initial offset,” herein. In addition to any initial offset, later changes in the resonant frequency of the crystals can introduce additional error into time calculations. These changes in the resonant frequency can result from the crystal aging, variations in the applied voltage, and changes in the temperature of the crystal.

More recently, instead of a crystal oscillator, devices are being equipped with integrated circuits (ICs) that provide a harmonic oscillator, for example, a CMOS based harmonic oscillator, to generate a frequency reference. These ICs can employ LC harmonic oscillator circuitry to generate frequency references of 10 MHz or more. Here too, clock generator circuitry can be employed to divide down the frequency reference which is then used to keep time. However, IC based frequency references are also subject to errors resulting from changes in temperature and/or applied voltage.

### SUMMARY OF INVENTION

In some aspects, the invention provides systems and methods to increase the accuracy of the time provided by distributed devices by adjusting the time determinations to compensate for errors, including the initial offset in the oscillator. According to one embodiment, the present invention provides a method and a system that allow clocks located in distributed devices to be synchronized with a signal provided by an atomic clock or some other standard and to do so in a sustainable manner where the accuracy of the clock improves over time-based on prior error determinations and error rates between the local clock included in the device and the time provided by the atomic clock or other reference. Further, in various embodiments, the preceding may be accomplished dynamically.

According to one aspect, the invention provides a method of synchronizing a clock included in a device. According to one embodiment the method includes acts of: (a) receiving with the device a clock signal including a time standard provided by a reference clock; (b) determining an elapsed time since a prior receipt of a clock signal including a time standard provided by the reference clock; (c) determining an error between a time provided by the clock signal received in act (a) and a time maintained by the clock included in the device; and (d) adjusting the time maintained by the clock included in the device to correct for the error determined by act (c), where the reference clock comprises an atomic clock. In one embodiment, one or more of steps (a), (b), (c) and (d) of the preceding method are performed automatically. According to a further embodiment, each of steps (a), (b), (c) and (d) of the method is performed automatically. According to a further embodiment, the method includes an act of wirelessly receiving the clock signal with the device.

According to another aspect, the invention provides a method of increasing an accuracy of a time provided by a device that employs an oscillator to keep track of time, where the device includes a processor and a memory. According to one embodiment, the method includes acts of (a) storing, in the memory, data concerning an initial offset associated with the oscillator in the device, the initial offset determined based on a comparison of a frequency output of the oscillator for a known period of time and an output of a frequency standard for the known period of time; and (b) generating an adjusted time with the device, the adjusted time generated by processing the frequency output provided by the oscillator to adjust for the initial offset identified in act (a).

According to another aspect, an apparatus includes a time reference including an oscillator having a known frequency output, a processor coupled to the time reference, an internal clock coupled to the processor; and a memory coupled to the processor. According to one embodiment, the memory includes an initial offset associated with the oscillator where the initial offset is determined based on a comparison of the frequency output of the oscillator for a known period of time and an output of a frequency standard for the known period of time. In a further embodiment, the processor is configured to employ data concerning the initial offset to process the frequency output provided by the oscillator such that a time provided by the internal clock is based on the frequency output of the oscillator adjusted to substantially eliminate the initial offset.

According to yet another aspect, a device includes a time reference including an oscillator providing a frequency output, a clock including at least one counter where the counter is configured to employ the frequency output to maintain a device-time, a display configured to display the device-time; and a manual synchronization device coupled to the clock. According to one embodiment, the manual synchronization device is configured to allow a user to synchronize the device-time with a time provided by an external time reference by activating the manual synchronization device at a completion of a period of elapsed time provided by the external time reference. According to a further embodiment, a single activation of the manual synchronization device advances the device-time to the time provided by the external time reference when the device-time lags the time provided by the external time reference by less than 30 seconds, and the single activation of the manual synchronization device rolls back the device-time to the time provided by the external time reference when the device-time leads the time provided by the external time reference by less than 30 seconds. According to one embodiment, the clock is configured to employ an error between the device-time and the time provided by the external time reference when the manual synchronization device is activated to adjust a target value of the at least one counter to eliminate the error.

### BRIEF DESCRIPTION OF DRAWINGS

The accompanying drawings, are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates system in accordance with one embodiment of the invention.

FIG. 2 illustrates a system in accordance with another embodiment of the invention.

FIG. 3 illustrates a process in accordance with a further embodiment of the invention.

FIG. 4 illustrates a process in accordance with yet another embodiment of the invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

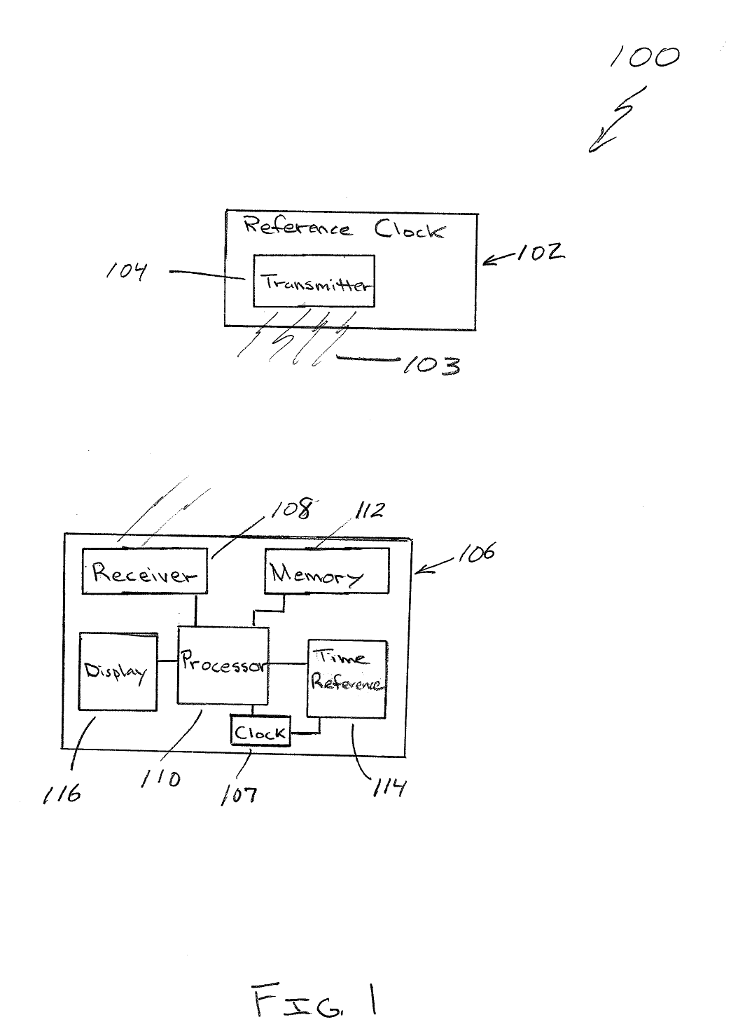

Referring to FIG. 1 in accordance with one embodiment, a system includes a reference clock 102, a transmitter 104 and a device 106 which is located remote from the reference clock. According to one embodiment, the reference clock is an atomic clock, that is, a clock that uses an atomic resonance frequency standard as its time keeping element. Further, according to one embodiment, the reference clock 102 is maintained by a national standards agency, for example, NIST. In accordance with some embodiments, the transmitter 104 is included with the reference clock 102 while in other embodiments, the transmitter is a separate apparatus from the reference clock 102. In these later embodiments, the reference clock provides the data concerning the reference clock signal (for example, the current time and date) to the transmitter for the transmitter 104 to communicate to one or a plurality of devices 106.

According to the illustrated embodiment, the device 106 includes a clock 107, a receiver 108, a processor 110, a memory 112, a time reference 114, and a display 116. The device 106 can be any type of device that employs a time reference 114 to provide data used to maintain a clock included in the device, for example, a watch, an alarm clock, a GPS, a computer, a DVR or “set-top box”, a satellite, a PDA, a mobile phone, and the like.

According to some embodiments, the clock 107 maintains a device-time, that is, the time kept at the device. In various embodiments, the clock 107 calculates the device-time while in other embodiments the clock 107 maintains the device-time which can be determined elsewhere in the device. According to some embodiments, the processor 110 determines the device-time and accurately maintains the current time kept by the clock 107 on a substantially continuous basis, that is, often enough to maintain the current time to the required decimal place, seconds, tenths of seconds, hundredths of seconds, etc. depending on the application. In some embodiments, the clock 107 is maintained as a value stored in the memory 112. According to another embodiment, the clock 107 is included as part of the time reference 114 which maintains the current time in the clock. Alternatively, in one embodiment, the time reference 114 is included in the clock 107 and the clock employs data provided by the time reference to determine the time. In yet another embodiment, the clock (either alone or in combination with the time reference 114) is included in the processor 110. The clock 107 may be embodied in hardware, software or a combination of hardware and software. For example, the clock 107 can include electronic circuitry and/or programs or algorithms which when executed by the clock determine the device-time.

In some embodiments, the time reference 114 includes a crystal oscillator (for example, a free running crystal oscillator) with a known resonant frequency. In accordance with one embodiment, the crystal oscillator includes electronic circuitry that uses the mechanical resonance of a vibrating crystal, for example a quartz crystal to create an electrical signal with a very precise frequency. In another embodiment, the time reference 114 includes an IC oscillator (for example, a CMOS harmonic oscillator) with a known output frequency.

In one embodiment, the time reference 114 may generate the time maintained by the device 106. In another embodiment, the time reference 114 provides data to the processor which determines the time at least in part from the data.

In accordance with some embodiments, the processor 110 is a CPU which communicates via a communication bus included in the device 106 with each of the clock 107, the receiver 108, the memory 112, the time reference 114 and the display 116. In further embodiments, the communication occurs over a plurality of communication buses. In some embodiments, the communication bus or busses allow each of the preceding elements included in the device 106 to communicate with one or more of the other elements.

According to one embodiment, the receiver 108 includes an antenna configured to receive a transmitted clock signal 103 which includes a time reference, for example, a radio signal. In addition to the preceding or alternatively, the receiver 108 can included an optical receiver or a port configured to couple the receiver 108 to a hardwired communication link over which clock signal 103 is transmitted.

In accordance with one embodiment, the processor 110 is included in a microcontroller that is employed in the device 106. In a further embodiment, each of the processor 110 and the memory 112 are included in a microcontroller. In various embodiments, the memory includes both RAM and ROM. For example, the memory can include any of Flash memory, EEPROM and SRAM either alone or in any combination with one another or in combination with other types of memory. In some embodiments, the memory 112 is used to store programs for execution by the processor 110 that calculate the time at the device 106 based on information provided by the time reference 114, information provided in the clock signal and/or information concerning a deviation known to exist in the time reference 114 relative to the time standard provided by the reference clock. In further embodiments, the memory 112 stores one or more programs that are employed by the processor to calibrate an output provided by the time reference 114.

According to various embodiments, the display 116 provides a visible display of the time. The display may include, for example, a digital display, an analog clock face or a clock represented in a graphical user interface. According to one embodiment, the device 106 does not include the display 116.

In general, the system 100 generates the reference clock signal 103 at the reference clock 102 which is then transmitted by the transmitter 104. In accordance with the illustrated embodiment, the clock signal is wirelessly transmitted, for example, via a low frequency signal transmitted by WWVB. Other forms of RF transmission can be employed to transmit the clock signal. In some embodiments, the reference clock signal is encoded with information including a time standard, for example, the hour, minute and second. In addition, in various embodiments, the clock signal may include one or more of the following: the year, day of year, and flags that indicate the status of Daylight Saving Time, leap years, and leap seconds.

According to one embodiment, the receiver 108 receives the reference clock signal transmitted by the transmitter 104 and communicates this information to the processor. In various embodiments, the receiver 108 performs one or more signal processing steps, for example, to identify the data corresponding to the time standard encoded in the clock signal. The processor executes one or more operations to employ the information provided by the reference clock signal to update the time provided by the clock 107, as is explained in further detail herein.

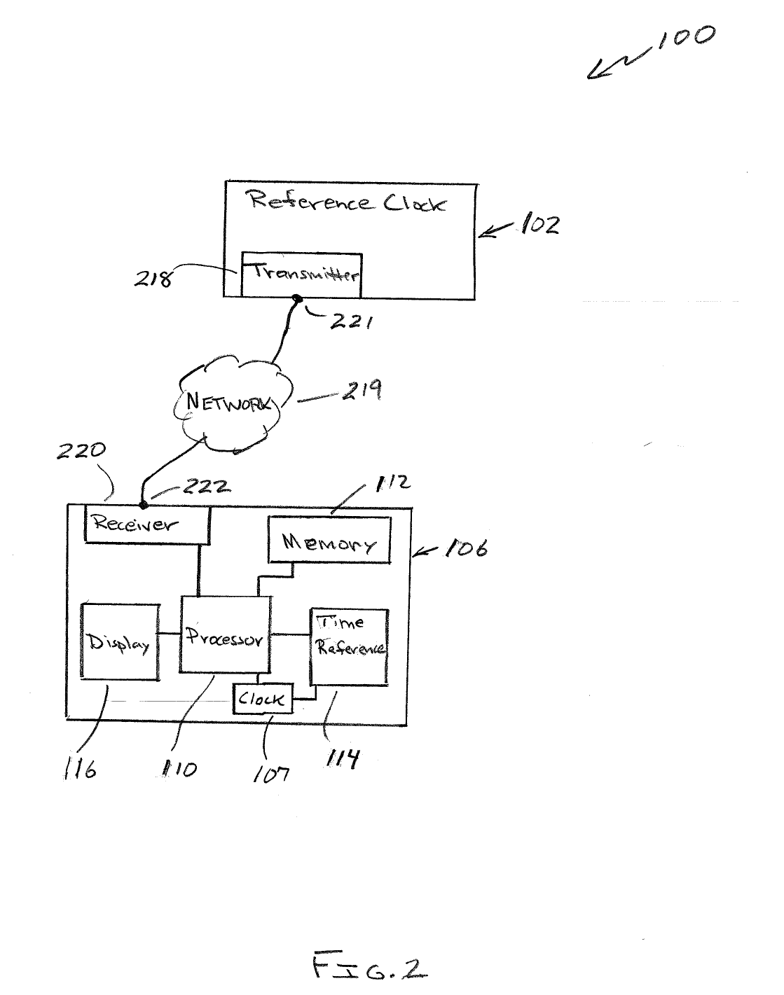

FIG. 2 illustrates another embodiment of the system 100 illustrated in FIG. 1 including a network 219 over which the clock signal is transmitted from the transmitter 218 to the receiver 220. In accordance with some embodiments, the transmitter 204 is included with the reference clock 102 while in other embodiments, the transmitter 204 is a separate apparatus from the reference clock 102. In the illustrated embodiment, the transmitter 218 includes a communication port 221 coupled to the network 219. The output port 218 can provide a hardwired connection to the network 219 according to one embodiment. The receiver 220 includes a communication port 222 that is coupled to the network 219. The communication port 222 can provided a hardwired connection of the device 106 to the network 219. In accordance with one embodiment, the communication port 222 includes a serial communication port, for example, a serial communication port configured to receive a clock signal including a time standard provided by a reference clock. In various embodiments, the network 219 may include one or a combination of local area networks, wide area networks (for example, the Internet), wireless or wired networks.

According to some embodiments in which the time reference 114 includes an oscillator, the device-time is calculated using an offset to compensate for an initial offset known to exist in the output of the oscillator. According to one embodiment, device-time is determined using one or more counters which increment (or decrement) based upon receipt of the frequency output of the oscillator and reset when the cumulative count reaches a predetermined value. In some embodiments, the resetting of the counter occurs along with, and in some embodiments, may trigger, a value in an associated counter being incremented. For example, a counter associated with a first unit of time (minutes) may increment when a counter associated with a second unit of time (seconds) resets. In some embodiments, one or more counters can be employed where they are associated with much smaller increments of time, for example, microseconds.

Further, to provide for the different frequency at which a unit of time changes, each counter may be configured with a unique value (for example, a unique target value) which corresponds to a value that when reached results in the counter being reset. That is, different counters may reset at different rates because, for example, the number of seconds changes at a rate that is 60 times the rate at which the number of minutes changes. According to one embodiment, a counter associated with the least significant digit (the smallest increment of time) receives the frequency output of the oscillator. Further, in this embodiment, the counts maintained by other counters used to provide device-time are driven off (either directly or indirectly) changes in the value provided by the counter associated with the least significant digit. In one example, the oscillator may provide a frequency output which is much greater than the frequency at which the least significant digit of the device-time is adjusted. Accordingly, a counter or series of counters can be employed to generate a signal at a decreased frequency which is more suitable for tracking the smallest increment of time which is provided by the clock. A series of additional counters can then be employed to track the more significant digits of the device-time, either directly or indirectly based on changes in value provided by the counter associated with the least significant digit of the device-time. In various embodiments, the counters may be included in one or more of the time reference 114, the clock 107 or the processor 110. Further, the counters may be maintained and the device-time may be calculated using hardware, software, firmware or any combination of the preceding.

According to some embodiments, the smallest unit of time maintained by the clock 107 is not displayed by the device 106. For example, the display 116 may only display hours, minutes and seconds even though tenths, hundredths or smaller units of time are available from the clock 107.

In accordance with one embodiment, the initial offset is stored in the device 106, for example, in firmware or software. The device employs the initial offset to automatically determine how many pulses the oscillator is ahead of or behind the desired target frequency output of the oscillator per unit of time. In one embodiment, the device 106 employs this information to automatically increment or decrement from the quantity of pulses a counter must receive before resetting (for example, to increment a unit of time and cause the next counter in the series to increment). In an alternate embodiment, the count that is reached to reset the counter remains unchanged and the count itself is periodically updated to account for the initial offset, i.e., the number of pulses per unit time that the frequency output of the oscillator varies from the output of the frequency standard. As a result, in some embodiments, the device automatically and on a continuous basis operates to maintain the accuracy of the time kept by the device 106 by eliminating an initial offset which was determined when the device was manufactured and/or initialized.

According to one embodiment, the time maintained by the clock 107 in the device 106 can be set manually. For example, a user may adjust/set the time via hardware input devices (for example, pushbuttons or other controls) or by electronic communication (for example, via an RF signal or a hardwired serial input). According to these embodiments, the device 106 can maintain the device-time using an algorithm that operates to eliminate the effect of the initial offset on the time maintained by the device. In accordance with one embodiment, the algorithm also maintains a record of the elapsed time since the clock 107 was last set manually and employs this record to further improve the accuracy of the time maintained by the device 106 when the time is manually updated in the future. In one embodiment, the elapsed time can be used to determine whether the device-time includes additional error or drift. That is, provided that the initial offset is accounted for in the execution of the algorithm, any error between a manually entered time and the device-time may be assumed to be the result of additional error, for example, error caused by any of crystal aging (where a crystal oscillator is used), variations in the applied voltage, and changes in the temperature of the oscillator.

In accordance with one embodiment, the device 106 includes an algorithm executed in software and/or firmware (or a combination of both) that calculates a difference (i.e., drift or error) between the frequency output of the oscillator included in the device 106 and the frequency output of an independent frequency standard. Further, in some embodiments, the algorithm modifies a target value at which a counter that is used in dividing down the frequency output resets. For example, the value that triggers a reset can be adjusted by incrementing or decrementing the value by a quantity of pulses for which the frequency output of the oscillator included in the device varies from the frequency standard. In accordance with one embodiment, this difference in frequency output includes both the initial offset and some amount of additional error. In an alternate embodiment, the count that is reached to reset the counter remains unchanged and the count itself is periodically updated to account for both the initial offset and any additional error, i.e., the number of pulses per unit time that the frequency output of the oscillator varies from the output of the frequency standard. The additional error may either increase the difference between the frequency output of the oscillator and the frequency standard (i.e., be in the same direction as the initial offset relative to the standard) or decrease the difference (i.e., be in the opposite direction as the initial offset relative to the standard). Embodiments of the preceding approach can automatically correct for additional error in either direction. In the preceding embodiments, the target value which triggers the reset of a first counter may correspond to a value at which one or more associated counters increment. According to various embodiments, the counter or counters are provided in any of software, hardware, firmware or a combination of the preceding.

According to yet another embodiment, the offset, both initial offset and additional offset, can be accounted for manually in the field. For example, a diagnostic tool can be used to determine a difference between the frequency output of the oscillator included in the device 106 and the frequency output of an independent frequency standard. According to one embodiment, a user can use that information to manually adjust the value of a counter so that the increment of time at which the counter resets more precisely matches the desired time-increment. In a further embodiment, a user can manually enter the current time provided from a highly accurate and reliable source (for example, an atomic clock) and the device can employ that information to determine the error in the device-time and a corresponding error in the frequency output of the oscillator.

In yet another embodiment, the device 106 which includes the clock 107 and the display 116 (for example, a DVR, a watch, etc.) can be equipped with an apparatus that simplifies a manual synchronization by the user of the time maintained by the clock 107 with a highly accurate and reliable source of time, for example, an atomic clock. According to one embodiment, the apparatus provides the user with the ability to correct for an error between the time provided by the clock 107 (for example, as displayed by the display 116) and the time provided by the time reference (e.g., the atomic clock) via a simple user action.

Various embodiments described herein provide approaches that can be employed to maintain a small error between the time provided by the clock and the time provided by the time reference, for example, by correcting for an offset determined at the time of manufacture of the device 106, correcting for a known error rate, and/or periodically synchronizing the clock with a time reference, etc. According to one embodiment, an error between the time provided by the clock 107 and the time provided by the time reference can be maintained at or below a relatively small value. For example, in one embodiment, the error can be maintained within less than 30 seconds of the time provided by the time reference.

According to some embodiments, the device is equipped with a synchronization device (for example, a switch, a pushbutton, an icon, etc.) that the user can select to manually reset the clock 107 to the time provided by the time reference. When selected, the device can be used to synchronize the time maintained by the clock with the time reference by initiating a correction of the device-time as displayed by the display 116, for example, by advancing (if the device-time is slow) or moving back (if the device-time is fast) the time provided by the clock 107 and displayed by the display 116.

In general, the preceding approach provides a user with a known manner of re-synchronizing the clock-time by allowing the user to synchronize the clock 107 at the completion of a period of elapsed time. In one embodiment where the device 106 displays minutes and seconds, the preceding approach can allow the clock to be synchronized at the transition between two consecutive minutes. For example, in one approach where the device 106 displays a time which is from 0-29 seconds faster than the time provided by the time reference, the user employs a synchronization device when the time reference reaches a transition between consecutive minutes. In this embodiment, the user monitors (visually via a display, audibly via an audible count, or a combination of the two) the time provided by the time-reference and activates the synchronization device at the transition between two consecutive minutes (i.e., at zero seconds of the time reference). According to this embodiment, the device 106 is displaying a time which includes X minutes and 1-29 seconds. Upon activation of the synchronization device, the clock 107 and associated display 116 are reset to 00 seconds of the existing minute.

According to a further embodiment, the device 106 displays a time which is from 0-29 seconds slower than the time provided by the time reference. According to this embodiment, the user monitors (visually via a display, audibly via an audible count, or a combination of the two) the time provided by the time-reference and activates the synchronizer at the transition between two consecutive minutes (i.e., at zero seconds of the time reference). According to this embodiment, the device 106 is displaying a time which includes X minutes and 31-59 seconds. Upon activation of the synchronization device, the clock 107 and the associated display 116 are reset to 00 seconds and advance to the start of the next minute.

According to some embodiments, the preceding approach can simplify the synchronization of the clock 107 by allowing a user to synchronize the clock with the selection of a synchronization device included in the device 106. Further in some embodiments, only a single synchronization device need be employed in the device 106, for example, a single switch, pushbutton or icon, etc. Accordingly, in one embodiment, the synchronization device can be activated by a single user act.

According to a further embodiment, the synchronization device provides the user with an ability to synchronize for errors which are anywhere from 1-59 seconds. In accordance with this embodiment, the synchronization device can include at least two devices for synchronizing the time. A first device for advancing the time provided by a clock which is behind the time provided by the time reference, and a second device for rolling back the time provided by a clock which is ahead of the time provided by the time reference. In accordance with this embodiment, the user monitors (visually via a display, audibly via an audible count, or a combination of the two) the time provided by the time-reference and activates the synchronization device at the transition between two consecutive minutes (i.e., at zero seconds of the time reference). According to this embodiment, the device is displaying a time which includes X minutes and 01-59 seconds. Where the time displayed by the device 106 is behind the time provided by the time-reference the user selects the first synchronization device and the clock 107, and associated display 116, are reset to 00 seconds and advance to the start of the next minute. Where the time displayed by device 106 is ahead of the time provided by the time-reference the user selects the second synchronization device and the clock 107, and associated display 116, are reset to 00 seconds and roll back to the start of the current minute.

Embodiments which employ a manual time synchronization can be employed in a wide variety of applications. In one embodiment, a user can synchronize their watch, PDA or other portable device at the push of a button (or selection of an icon) by comparing the time displayed by the device with the time provided by a time reference which is displayed in a display screen such as provided by an electronic system. That is, the display screen may be included in a system such as a computer terminal, laptop computer, etc. which is connected to a network (wired or wireless) via which it receives the time reference signal from the source of the time reference. The user can observe the time provided by the display screen to determine when the time provided by the reference reaches a selected transition time. The user then selects the synchronization device included in the device (e.g., a sync pushbutton, a sync icon, etc.) to initiate the change in the time provided by the clock 107 as described above.

According to some embodiments, the time provided by the clock 107 is maintained using an algorithm implemented in hardware, software, firmware or any combination of the preceding, in the device 106. Accordingly, some embodiments can employ an algorithm to determine the error in the time provided by the clock when the manual synchronization occurs. That is, the algorithm can determine the amount of correction that was required to synchronize the clock with the time reference and then employs that information to adjust the target value(s) of one or more counters to eliminate the error. In some embodiments, the elapsed time from the previous synchronization can also be determined by the device 106 and employed by the algorithm when adjusting the value of the counter(s). According to these embodiments, the error and the elapsed time can be stored in memory.

According to one embodiment, the time maintained by the clock 107 in the device 106 is adjusted automatically based on data provided in a clock signal that includes a time standard, for example, an atomic clock time standard. According to these embodiments, the device 106 can maintain the device-time using an algorithm that eliminates the effect of the initial offset on the time maintained by the device. In accordance with one embodiment, the algorithm also maintains a record of the elapsed time since the clock 107 was last set in response to the receipt of the clock signal and employs this information to further improve the accuracy of the time maintained by the device 106. In one embodiment, the elapsed time can be used to determine whether the device-time includes additional error (for example, error originating from drift in the frequency output of the oscillator) since the receipt of the immediately preceding clock signal. That is, provided that the initial offset is accounted for in the execution of the algorithm, any error between a time provided by the clock signal and the device-time may be assumed to be the result of additional error, for example, error caused by any of crystal aging (where a crystal oscillator is used), variations in the applied voltage, and changes in the temperature of the oscillator.

In accordance with one embodiment, the device 106 includes an algorithm executed in software and/or firmware (or a combination of both) that calculates a difference (i.e., drift or error) between the frequency output of the oscillator included in the device 106 and the frequency output of an independent frequency standard based (at least in part) on the data provided by the clock signal. Further, in some embodiments, the algorithm modifies a target value for a counter which is used in dividing down the frequency output, for example, by incrementing or decrementing the target value by a quantity of pulses for which the frequency output of the oscillator included in the device varies from the frequency standard. In an alternate embodiment, the target count that corresponds to the reset-value of the counter remains unchanged and the count itself is periodically updated to account for the both the initial offset and the additional error, i.e., the number of pulses per unit time that the frequency output of the oscillator varies from the output of the frequency standard. The additional error may either increase the difference between the frequency output of the oscillator and the frequency standard (i.e., be in the same direction as the initial offset relative to the standard) or decrease the difference (i.e., be in the opposite direction as the initial offset relative to the standard). Embodiments of the preceding approach can automatically correct for additional error in either direction. In the preceding embodiments, the target value which triggers the reset of a first counter may correspond to a value (and/or a point in time) at which one or more associated counters increment. According to various embodiments, the counter or counters are provided in any of software, hardware, firmware or a combination of the preceding.

According to yet another embodiment, a user can manually initiate a comparison between the device-time and the time provided by the time standard. In other words, a user can allow the device-time to be determined based on information concerning the initial offset without making a determination of how other factors may be contributing to the frequency output of the oscillator (and also contributing to the corresponding time calculations). At some point in time (perhaps motivated by some change in circumstance of the device 106), the user can then manually activate a comparison to determine the actual difference between the frequency output of the oscillator and the frequency output of the standard. In accordance with one embodiment, the results of the manually-initiated comparison can be employed in an algorithm executed in software and/or firmware (or a combination of both) to calculate a difference (i.e., drift or error) between the frequency output of the oscillator included in the device 106 and the frequency output of an independent frequency standard based (at least in part) on the data provided by the clock signal. In some embodiments, the algorithm modifies a target value corresponding to the reset value of a counter which is used in dividing down the frequency output, for example, by incrementing or decrementing the target value by a quantity of pulses for which the frequency output of the oscillator included in the device 106 differs from the frequency output of an independent frequency standard. In an alternate embodiment, the count that is reached to reset the counter remains unchanged and the count itself is periodically updated to account for the initial offset, i.e., the number of pulses per unit time that the frequency output of the oscillator varies from the output of the frequency standard. Accordingly, the preceding approach can account for both initial error and any additional error resulting from a change in the frequency output of the oscillator determined as a result of a manually-initiated comparison.

In addition, the preceding embodiments can employ the elapsed time between a first determination of the drift provided by the oscillator relative to the frequency standard and a second determination of the drift provided by the oscillator relative to the frequency standard to determine the error per unit time. In various embodiments, the error per unit time can be employed in an algorithm to periodically compensate the determination of the device-time for the offset (initial offset, additional offset or each of the preceding) included in the frequency output of the oscillator. In accordance with one embodiment, this approach can be employed to accelerate or decelerate the count recorded by the counter.

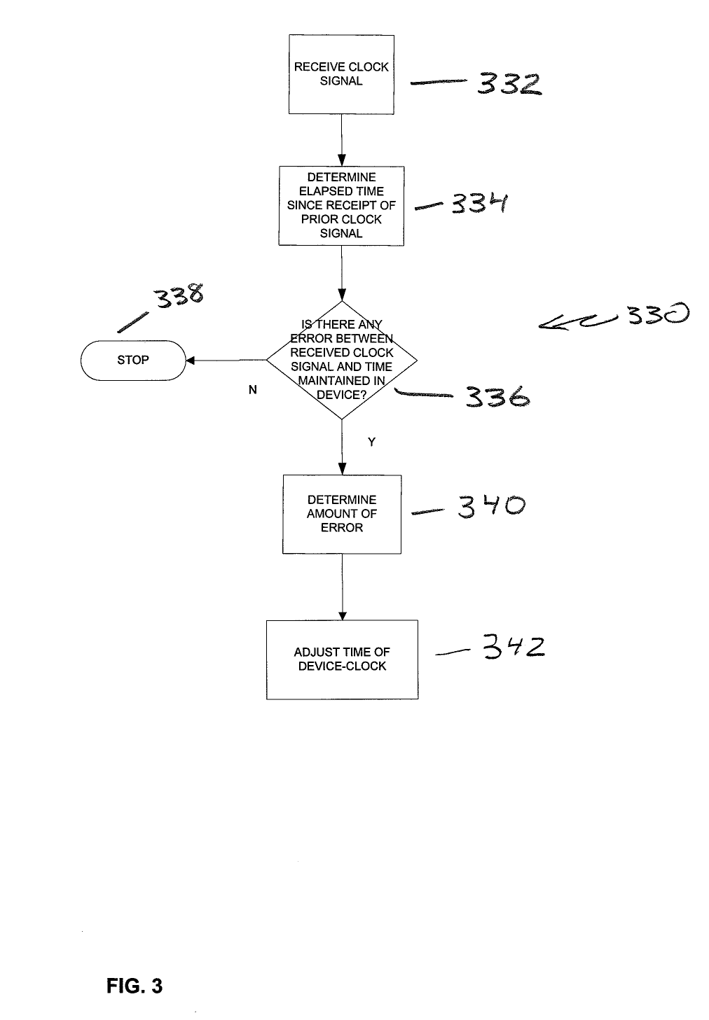

Referring to FIG. 3, a process 330 is provided to calibrate the clock 107 included in the device 106. At act 332, a clock signal including a time standard established by a reference clock is received by the device 106. At act 334, an elapsed time since a prior receipt of a clock signal including a time standard established by the reference clock is determined. For example, the clock signal can include the date in addition to the time and the device 106 can also maintain the date in addition to the time. According to this embodiment, the memory 112 can store a date and time of the receipt of the last clock signal received by the device 106. The processor 110 can employ this information along with the date and time of receipt of the current clock signal to determine the elapsed time between receipt of clock signals.

At act 336, a determination is made whether there is any error between the clock signal received at act 332 and the time maintained by the device 106. For example, the processor 110 can be employed to determine whether there is an error between the time provided by the clock signal and the time maintained by the clock 107. Where there is no error (or for example, the error is less than a pre-determined threshold) the process reaches a stop point 338.

Where an error is identified, the process 330 proceeds to act 340. At act 340, the amount of the error is determined, for example, so that the time maintained by the device can be corrected, i.e., synchronized to the time provided by the reference clock. For example, act 340 can include a determination of both a magnitude and direction of the error to provide an approach that can correct conditions where the clock 107 is ahead or behind the reference clock, e.g., whether the clock 107 is operating faster or slower than the reference clock 102 (typically the preceding is calculated based on a difference in pulses per second as determined by an accumulated error over an elapsed period of time.

The process 330 proceeds to act 342 where the time maintained by the device 106 is adjusted to substantially eliminate the error determined at act 340. For example, the processor may execute a time-calculation so that the current time is always available from the clock 107, for example, substantially continuously execute the time-calculation. According to one embodiment, the algorithm employed to execute the time-calculation is updated with the error determination so that the results of the time calculations made following act 342 are synchronized with the reference clock 102. In another embodiment, the clock 107 included in the device generates and outputs the device-time. According to this embodiment, the output of the clock 107 is adjusted to eliminate the error determined at act 340.

It should be apparent that that the process 330 can include different acts, additional acts or fewer acts than those illustrated in FIG. 3. In one embodiment, act 336 and act 340 are combined in a single act in which the determination of whether the device-time matches the reference-time includes the act of determining the amount of any error over an elapsed period of time. In a further embodiment, the acts included in the process 330 are reordered. For example, act 334 can follow the act 340. In yet another embodiment, the act 334 is not included in the process 330.

In accordance with some embodiments, one or more of the acts included in the process 330 can be performed automatically. For example, they can be automatically performed by the device 106 using one or more algorithms.

As described above, some embodiments can be employed to synchronize a time maintained by the device 106 with a time of a reference clock 102. In some further embodiments, the results from one or more acts included in the process 330 can be used so that the device 106 maintains an accurate time (a time synchronized with the time of the reference clock) and does so for an extended period. For example, the processor 110 may use the elapsed time and the error to determine an error rate at which the time maintained by the device 106 varies from the time provided by the reference clock 102.

In other words, when the device 106 is operating in a “free-running” mode independent of any communication from the reference clock 102, the processor 110 can operate to continuously update the time determined by the device 106 to correct for errors that would otherwise occur. Further, where the clock 107 or the time reference 114 is generating the time employed by the device (rather than the processor), the time reference 114 or clock 107, respectively, can employ the error rate to continuously update the time calculations to correct for errors that would otherwise occur.

According to one embodiment, the error-correction by the device 106 is based on the error rate determined following the most recent receipt of the clock signal transmitted from the transmitter 104. Accordingly, the accuracy of the time provided by the local clock 114 can be improved in the period between synchronization cycles (i.e., between receipt of clock signals). Further, in some embodiments, the preceding approach provides for the continuously maintained accuracy of the time provided by the local clock 114 over the long term.

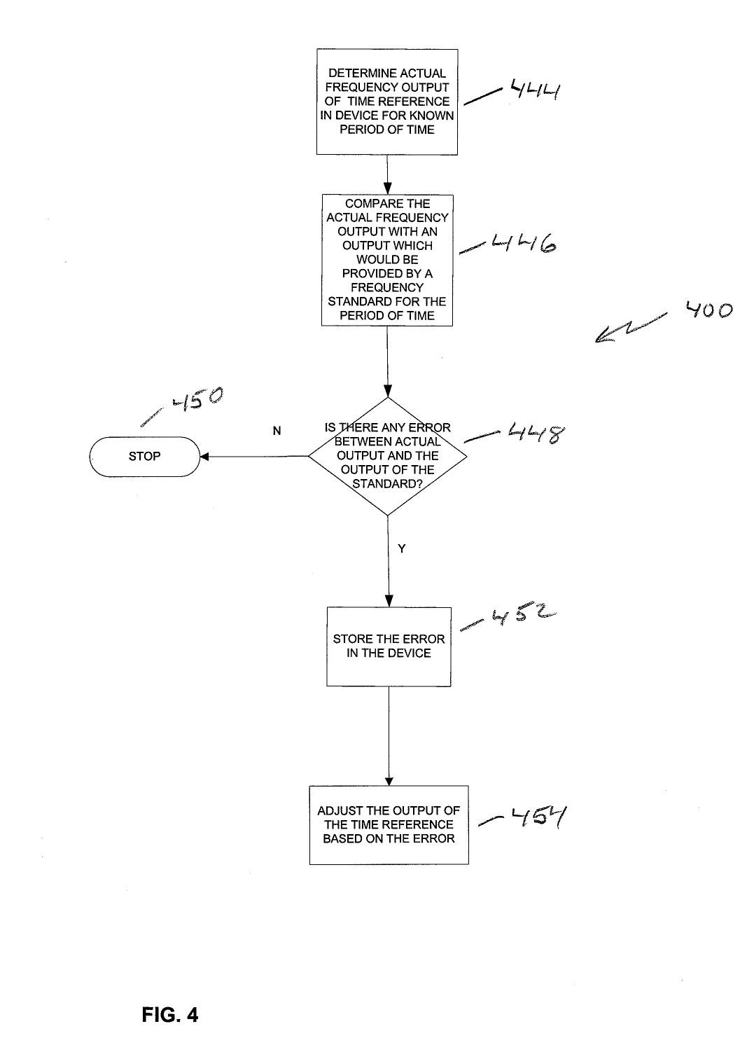

According to some embodiments, the time reference itself is corrected for imprecision/errors in the data that it provides. Because the data provided by the time reference 114 is used to establish the device-time maintained by the clock 107 improvements in the accuracy of the time reference 114 results in a more accurate device time. Referring to FIG. 4, a process 400 provides an error correction for the time reference 114 included in the device 106 in accordance with one embodiment. According to this embodiment, the time reference 114 includes an oscillator with a target resonant frequency. The term “target resonant frequency” as employed here refers to a frequency output which oscillator is expected to maintain, for example, the frequency output that a crystal oscillator is expected to maintain based, for example, on the material of the crystal and the configuration of the circuitry of the crystal oscillator. Or, for example, where an IC oscillator is employed, the frequency output that the IC oscillator is expected to maintain based, for example, on the configuration of the circuitry and/or values of the circuit elements included therein (capacitance, inductance, resistance, etc.).

Differences between the actual resonant frequency of the oscillator and the target resonant frequency often occur due to manufacturing tolerances; differences in the structure of crystals, changes in crystal temperature, and crystal age (where a crystal oscillator is used); variations in applied voltage; etc. In some embodiments, the process 400 is employed to adjust for a difference between the target resonance frequency and the actual resonant frequency of the oscillator.

According to the illustrated embodiment, the process 400 begins at act 444 where the frequency output of the time reference 114 is determined for a known period of time. The information determined at act 444 is employed at act 446 where a comparison is made between the actual frequency output of the time reference 114 and a frequency output which would be provided by a known frequency standard for the known period. According to one embodiment, the frequency standard is provided by an oscillator (an actual device or a modeled device) having substantially identical design as the oscillator employed in the device. The process 400 moves to act 448 where a determination is made whether there is any error between the actual frequency output and the output of the frequency standard. Where there is no error (or for example, the error is less than a pre-determined threshold) the process reaches a stop point 450 and the output of the time reference 114 is not adjusted.

Where an error is identified, the process 400 proceeds to act 452. At act 452, the amount of the error is stored in the device, for example, in the memory 112 of the device 106. At act 454, the output of the time reference 114 is adjusted based on the error to provide a more accurate reference for time-keeping by the clock 107.

It should be apparent that that the process 400 can include different acts, additional acts or fewer acts than those illustrated in FIG. 4. Further, acts may be combined, modified and reordered depending upon the embodiment.

In accordance with one embodiment, acts 444, 446 and 448 are performed by the manufacturer of the device 106 prior to shipment to determine whether any offset (i.e., error correction) should be made to maintain the accuracy of the time generated by the clock 107. Where an error correction is required, act 454 can also be performed by the manufacturer so that the known error is stored in the device where it can be employed by the device to maintain a more accurate time of the clock 107 when the device is used by an end user. In some embodiments of the process 400, the error-correction of the output of the time reference 114 is performed in software. In accordance with these embodiments, the algorithm used by the device 106 to determine the time includes the adjustment necessary to correct for the error determined at act 448. According to some embodiments, the actual error is not stored in the device and act 452 is instead replaced by an act which establishes or modifies the counters referenced-limit (i.e., the target count that is reached to reset the counter) in the algorithm used by the device to calculate the time. In an alternate embodiment, the counter's referenced limit remains unchanged and the count itself is periodically updated in the algorithm to account for the actual error.

In accordance with some embodiments, one or more of the acts included in the process 400 can be performed automatically. For example, they can be automatically performed by the device 106 using one or more algorithms.

According to one embodiment, the manufacturer of an integrated circuit (IC) that provides a harmonic oscillator (for example, a CMOS based harmonic oscillator) corrects the frequency output of the harmonic oscillator during manufacture. According to some embodiments, the frequency output of the oscillator is compared with an output of a frequency standard to determine the accuracy of the oscillator included in the IC. Where an error in the output of the oscillator is found, the manufacturer can adjust the frequency reference to reduce or eliminate the error during manufacture and prior to shipment. According to one embodiment, the error correction can be accomplished in firmware. Accordingly, in some embodiments, the process 400 can be performed during the manufacture of a time reference.

In some embodiments where an error rate is known, the time maintained by the clock 107 may be periodically adjusted rather than being adjusted on a continuous basis. For example, once synchronized with the reference clock 102, the clock 107 may maintain a time that is within the required accuracy for a period of time during which the time maintained by the clock 107 gradually becomes less accurate (i.e., drifts). Eventually, the inaccuracy may exceed a predetermined allowable threshold. According to some embodiments, the device 106 may use the known error rate to self-calibrate (and even self-synchronize with the time of the reference clock 102) the time maintained by the clock 107 during periods where the clock signal 103 is not received by the device 106. In this embodiment, the processor 100 may monitor the elapsed time between receipt of the clock signal 103 and the known error rate to determine when a self-calibration is necessary.

In accordance with another embodiment, the device 106 periodically adjusts the time of the clock 107 for a known drift to prevent the device-time from ever reaching a predetermined level of inaccuracy, for example, to maintain the device-time synchronized with the time of the reference-clock. Further, where the preceding operation is performed over a period of time, some embodiments provide a means for improving the accuracy in reducing the error in addition to the synchronization described above. For example, the device 102 may receive a clock signal from the reference clock compare it to the time of the local clock and determine whether the error rate has declined since the prior synchronization.

In some embodiments, the device-time can be maintained to substantially eliminate drift, in particular, where the error is linear. In addition, however, some embodiments can employ information provided by a newly-received clock signal to update the error rate calculations and update the time calculations determined by the device to reflect a change in the error rate. The preceding approach can be particularly useful where, for example, the error introduced by the oscillator is non-linear (such as when the accuracy is affect by a change in temperature of the time reference 114).

The method and system described herein can be provided in embodiments that include both hardware and software. In accordance with some embodiments, software is employed to provide the algorithms used by the processor 110 to either or both synchronize the time provided by the clock 107 with the time provided by the reference clock 102 and to calibrate the time provided by the clock 107.

Although the clock 107 has been described in some embodiments as a clock that provides a time based on an oscillator other time references may be employed.

According to one embodiment, the device 106 is included in a microchip which includes an oscillator, for example, a free running crystal oscillator or an IC oscillator. For example, the device 106 may be fabricated at the wafer level. In some embodiments, the microchip can provide any of the functionality described herein.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of synchronizing a clock included in a device, the method comprising acts of:
(a) receiving with the device a clock signal including a time standard provided by a reference clock;
(b) determining an elapsed time since a prior receipt of a clock signal including a time standard provided by the reference clock;
(c) determining an error between a time provided by the clock signal received in act (a) and a time maintained by the clock included in the device; and
(d) adjusting the time maintained by the clock included in the device to correct for the error determined by act (c),
wherein the reference clock comprises an atomic clock.

2. The method of claim 1, further comprising an act of determining an error rate from the elapsed time and the error.

3. The method of claim 2, further comprising an act of employing the error rate to improve an accuracy of the time maintained by the clock included in the device subsequent to act (d).

4. The method of claim 2, wherein the clock signal is a first clock signal, wherein the method further comprises an act of employing the error rate to adjust the time maintained by the clock included in the device at a time subsequent to act (d) and prior to a receipt of a second clock signal including the time standard provided by the reference clock.

5. The method of claim 4, wherein the elapsed time is a first elapsed time, wherein the method further comprises an act of determining a second elapsed time based on a time of a receipt of the second clock signal and a time at which act (d) occurs.

6. The method of claim 5, wherein the error is a first error, wherein the error rate is a first error rate, wherein the method further comprises acts of:
determining a second error as an error between a time provided by the second clock signal and the time maintained by the clock included in the device; and
determining a second error rate from the second elapsed time and the second error, wherein the second error rate is different than the first error rate.

7. The method of claim 6, further comprising an act of employing the second error rate to further improve an accuracy of the time maintained by the clock included in the device subsequent to the act of determining the second error rate.

8. The method of claim 4, further comprising an act of employing the error rate to make a series of adjustments to the time maintained by the clock included in the device between the time subsequent to act (d) and the receipt of the second clock signal.

9. A method of increasing an accuracy of a time provided by a device that employs an oscillator to keep track of time, the device including a processor and a memory, the method comprising acts of:
(a) storing, in the memory, data concerning an initial offset associated with the oscillator in the device, the initial offset determined based on a comparison of a frequency output of the oscillator for a known period of time and an output of a frequency standard for the known period of time; and
(b) generating an adjusted time with the device, the adjusted time generated by processing the frequency output provided by the oscillator to adjust for the initial offset identified in act (a).

10. The method of claim 9, wherein the device includes at least one counter, the method further comprising acts of:
storing in the at least one counter a value concerning an increment of time;
adjusting the value of the at least one counter in response to the frequency output of the oscillator; and
adjusting the value of the at least one counter to compensate for the initial offset.

11. The method of claim 10, wherein the device includes a clock, wherein the method further comprises acts of:
receiving with the device a clock signal including a time standard provided by a reference clock;
determining an elapsed time since a prior receipt of a clock signal including a time standard provided by the reference clock;
determining whether any error exists between a time provided by the clock signal received in the act of receiving and a time maintained by the clock included in the device; and
where an error exists, determining an error per unit time.

12. The method of claim 11, further comprising an act of adjusting the value of the at least one counter to compensate for the error.

13. The method of claim 12, wherein the device includes an IC oscillator, the method further comprising acts of:
employing an algorithm to maintain the time provided by the device; and
adjusting the value of the at least one counter with the algorithm.

14. The method of claim 9, wherein the device includes one of an IC oscillator and a free running crystal oscillator, the method further comprising an act of performing acts (a) and (b) prior to receipt of the device by an end user.

15. The method of claim 10, wherein the device includes a clock, wherein the method further comprises acts of:
receiving with the device a manually-entered clock signal;
determining an elapsed time since a prior receipt of the manually-entered clock signal;
determining whether any error exists between a time provided by the clock signal received in the act of receiving and a time maintained by the clock included in the device; and
adjusting the value of the at least one counter to compensate for the error.

16. An apparatus comprising:
a time reference including an oscillator having a known frequency output;
a processor coupled to the time reference;
an internal clock coupled to the processor; and
a memory coupled to the processor, the memory including an initial offset associated with the oscillator where the initial offset is determined based on a comparison of the frequency output of the oscillator for a known period of time and an output of a frequency standard for the known period of time,
wherein the processor is configured to employ data concerning the initial offset to process the frequency output provided by the oscillator such that a time provided by the internal clock is based on the frequency output of the oscillator adjusted to substantially eliminate the initial offset.

17. The apparatus of claim 16, further comprising at least one counter configured to store a value concerning an increment of time, wherein the processor is configured to adjust the value of the at least one counter in response to the frequency output of the oscillator while compensating for the initial offset.

18. The apparatus of claim 17, further comprising a receiver coupled to the processor, the receiver configured to receive a clock signal including a time standard provided by a reference clock, wherein the processor is configured to determine an elapsed time since a prior receipt of a clock signal including a time standard provided by the reference clock and to determine whether any error exists between a time provided by the clock signal received in the act of receiving and a time maintained by the internal clock.

19. The apparatus of claim 18, wherein the processor is further configured to, where an error exists, determine an error per unit time and to adjust the value of the at least one counter to compensate for the error.

20. A device comprising:
a time reference including an oscillator providing a frequency output;
a clock including at least one counter and configured to employ the frequency output to maintain a device-time;
a display configured to display the device-time; and
a manual synchronization device coupled to the clock, the manual synchronization device configured to allow a user to synchronize the device-time with a time provided by an external time reference by activating the manual synchronization device at a completion of a period of elapsed time provided by the external time reference,
wherein a single activation of the manual synchronization device advances the device-time to the time provided by the external time reference when the device-time lags the time provided by the external time reference by less than 30 seconds,
wherein the single activation of the manual synchronization device rolls back the device-time to the time provided by the external time reference when the device-time leads the time provided by the external time reference by less than 30 seconds, and
wherein the clock is configured to employ an error between the device-time and the time provided by the external time reference when the manual synchronization device is activated to adjust a target value of the at least one counter to eliminate the error.

21. The device of claim 20 further comprising a processor that includes an algorithm configured to determine the error between the device-time and the time provided by the external time reference and to adjust the target value of the at least one counter.

22. The device of claim 20, wherein the manual synchronization device includes one of a pushbutton, a switch, and an icon rendered in a display.

23. The device of claim 22, wherein each of the time reference, the clock, the display and the manual synchronization device are all integral to one of a watch and a handheld device.
